(19) United States
(12) Patent Application Publication
(10) Pub. No.: US 2002/0126840 A1
(43) Pub. Date: Sep. 12, 2002

(54) Method and apparatus for adapting symetric key algorithm to semi symetric algorithm

(76) Inventors: Virginia L. Robbins, Hillsboro, OR (US); David Palmer, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/805,299

(22) Filed: Mar. 12, 2001

(51) Int. Cl. H04L 9/00

(52) U.S. Cl. 380/44

(57) ABSTRACT

A circuit is presented including a key generating section. The key generating section generates a plurality of individual keys based on a main key. A decryption generating section is connected to the key generating section and a main decryption section. The decryption generating section generates a plurality of individual decryption processes based on the main decryption section and the plurality of individual keys. Also included is a main encryption section. The main encryption section uses the main key to encrypt content. Additionally, a method is presented that generates a plurality of individual keys based on a main key. The method also generates a plurality of individual decryption processes based on a main decryption process and the plurality of individual keys. Content is encrypted based on an encryption process and the main key.

### BACKGROUND OF THE INVENTION

1. Field of the Invention

This invention relates to content encryption/decryption, and more particularly to a method and apparatus for a semi-symmetric key algorithm.

2. Description of the Related Art

In many of today's encryption/decryption algorithms, a symmetric key cryptography is used. Symmetric key cryptography is a system where a sender and receiver of a message share a single common key that is used to encrypt/decrypt the message. FIG. 1 illustrates a symmetric key cryptology system having single symmetric key 110, encryption process 120, decryption process 130, content 140, and cypher-content 150. A method that can use two keys is called public key cryptology, which is also known as asymmetric cryptology. In a public key cryptology system, a public key is used to encrypt messages and a private key is used to decrypt messages. The public key is known to everyone and the private key is only known to the recipient of the message. Decryption process 130 is typically well known, and a user can install a decryption algorithm by means such as a software package. Symmetric key 110 may be encrypted with public/private schemes, such as a pretty good privacy (PGP) scheme. FIG. 2 illustrates a public key cryptology system having public keys 201, 202, 210 (where public key 210 represents the nth public key), ecryption processes 211, 212, 220 (where ecryption process 220 represents the nth encryption process), content 230, cypher content 241, 242, 250 (where cypher content 250 represents the nth cypher content), private keys 251, 252, 260 (where private key 260 represents the nth private key).

Symmetric key systems are simpler and faster than public key systems. One problem with symmetric key cryptology systems is that the sender and receiver must somehow exchange the one key in a secure manner. Public key encryption avoids the problem of exchanging the single key in a secure manner since the public key can be exchanged in a non-secure manner. The private key in the public encryption system is never transmitted. In a public key cryptology system, however, one disadvantage is an encrypted message can only be sent to a single recipient. Therefore, since a recipient's public key must be used to encrypt the message, sending to a list of recipients is not practical using a public key cryptology system.

While these systems of encryption are generally reliable, there are other drawbacks in today's emerging Internet world of various distributed content. Since only a single key is used, whether public or symmetric, once the key is compromised, unauthorized access to content may occur. Further, only a single decryption system is implemented. Therefore, once the method of decryption is compromised, unauthorized access may occur.

### BRIEF DESCRIPTION OF THE DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 illustrates a symmetric key system.

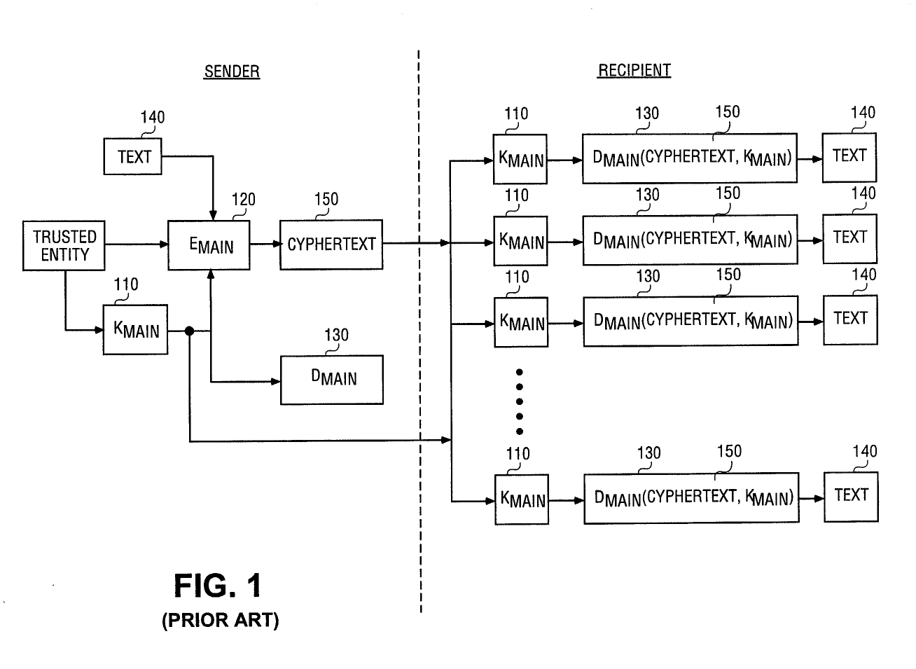

FIG. 2 illustrates a public key encryption system.

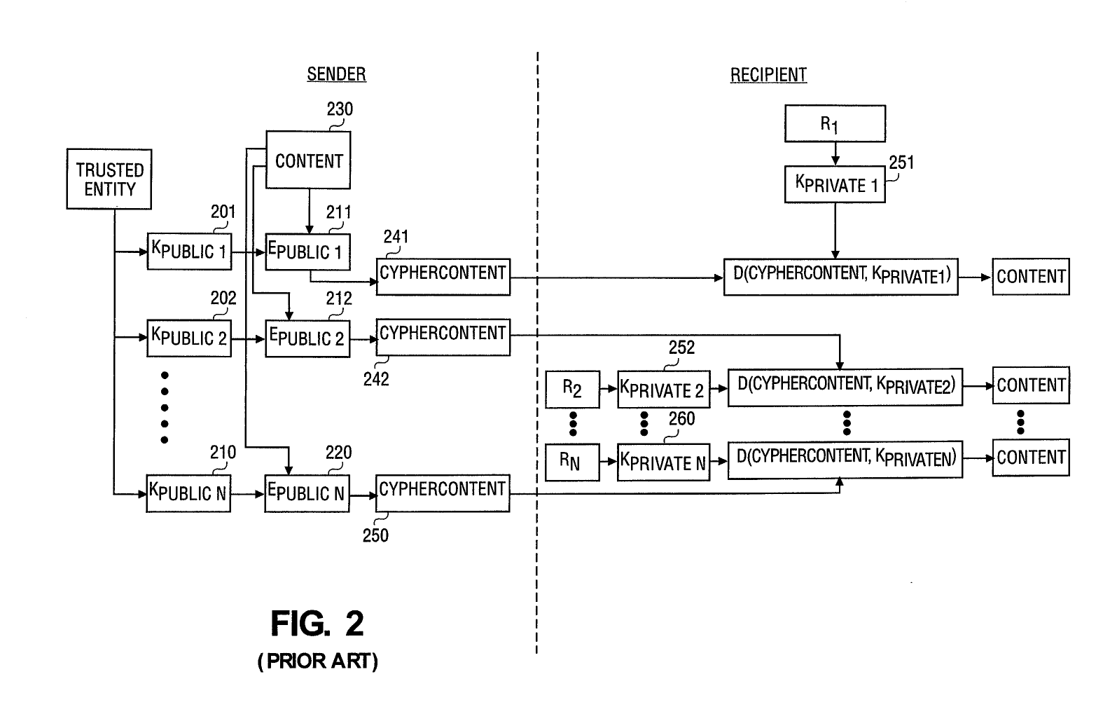

FIG. 3 illustrates an embodiment of the invention using a semi-symmetric key.

FIG. 4 illustrates a block diagram of a process of an embodiment of the invention using a semi-symmetric key and a plurality of decryption algorithms.

FIG. 5 illustrates an embodiment of the invention using a semi-symmetric key and generating a plurality of encryption agents.

FIG. 6 illustrates a flow diagram of a process of an embodiment of the invention for receiving a message from a sender.

### DETAILED DESCRIPTION OF THE INVENTION

The invention generally relates to a method and apparatus where a semi-symmetric cryptology system is used. Referring to the figures, exemplary embodiments of the invention will now be described. The exemplary embodiments are provided to illustrate the invention and should not be construed as limiting the scope of the invention.

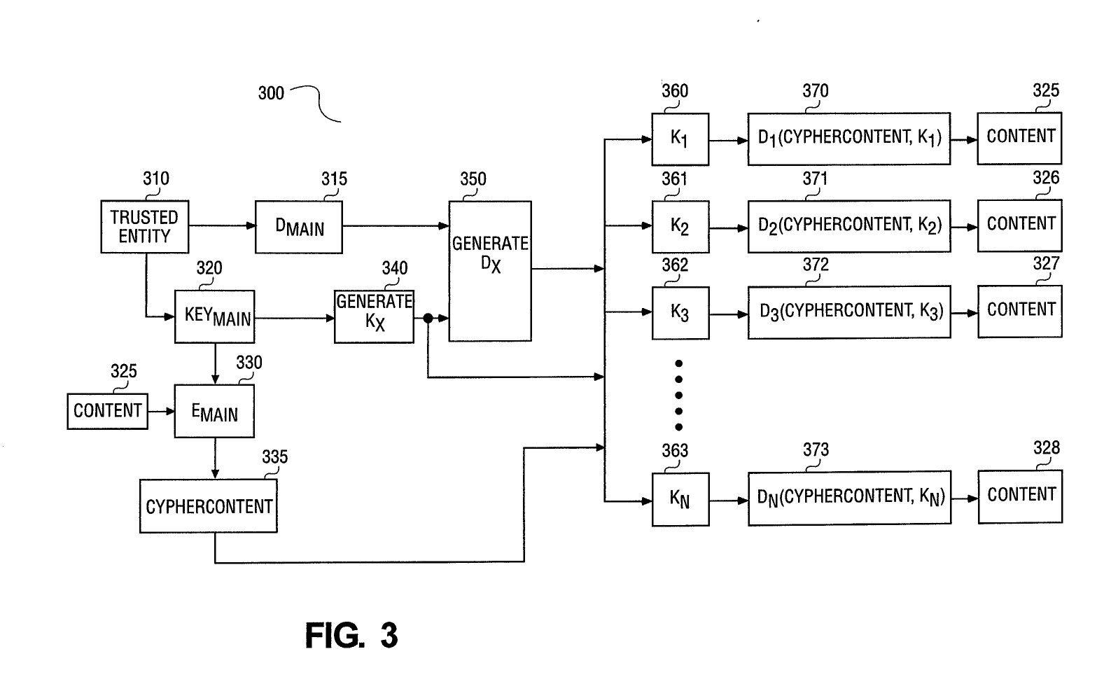

FIG. 3 illustrates an embodiment of the invention comprising semi-symmetric encryption/decryption system 300. Semi-symmetric system 300 comprises trusted entity 310, main decryption section or process 315, main key 320, main encryption section or process 330, decryption generator section or process 350, and key generator section or process 340. Main decryption section or process 315, main encryption section or process 330, decryption generator section or process 350, and key generator section or process 340 of semi-symmetric encryption/decryption system 300 may be incorporated on a circuit or on a machine readable storage device readable by a machine, such as a computer system. Main key 320 can be any cryptographic key having large enough size and randomness to allow for enough entropy to help prevent compromise by various techniques, such as a brute force technique. Also, main key 320 should be periodically modified to decrease the chance of main key 320 being compromised. Content 325 is content that is desired to be encrypted. Content 325 may be content such as text, moving picture experts group (MPEG) files, MPEG audio layer 3 (MP3) files, video on demand (VOD) streams, etc. Content 325 may also be any formatted file to be created in the future. Main encryption section or process 330 encrypts content 325 to produce cypher-content 335. Main encryption section or process 330 may be or include any standard encryption technique, advanced technique or custom encryption technique. Main decryption section or process 315 may be or include any standard decryption technique, advanced technique or custom decryption technique, and is implemented to correspond to main encryption section or process 330. Cypher-content 335 is then distributed to clients by conventional means, such as downloaded through a network, sent as an email attachment (.e.g., Internet), or recordable medium (floppy disk, CD-ROM, etc.).

Key generator section or process 340 generates individual keys 360, 361, 362, and 363. Key 363 is the nth key generated. Decryption generator section or process 350 generates individual decryption processes 370, 371, 372 and 373. Decryption process 373 represents the nth decryption process. Each decryption process 370, 371, 372, 373 uses the specific key, 360, 361, 362, 363, generated for the specific decryption process.

In one embodiment, key generator section or process 340 uses an invertible function to generate individual client keys. The invertible function may be any invertible mathematical function suitable for creating a plurality of individual keys. For example, if the invertible function is Fₓ(Key)=Key−X+3, then the inverted function F⁻¹ₓ(Key)=Key+X−3. Individual keys 360, 361, 362, and 363 are then distributed to clients by conventional means, such as downloaded through a network, sent as an email attachment (.e.g., Internet), recordable medium (floppy disk, CD-ROM, etc.), or by conventional mail. Since main key 320 may be modified periodically, individual keys 360, 361, 362, and 363 would be generated based on the modified key, and then distributed accordingly.

Decryption generator section or process 350 uses main decryption section or process 315 and keys generated from key generator process 340 as inputs to generate individual decryption processes 370, 371, 372, and 373. Each decryption process 370, 371, 372, 373 is a variation of main decryption process 315. Decryption processes 370, 371, 372, and 373 are then distributed to clients by conventional means, such as downloaded through a network, sent as an email attachment (.e.g., Internet), or recordable medium (floppy disk, CDROM, etc.). Since main key 320 may be modified periodically, decryption processes 370, 371,372, and 373 need to be re-generated and distributed accordingly;

For ease of discussion, an example of an embodiment of the invention is presented as follows.

E( ) represents an encryption algorithm.

D( ) represents a decryption algorithm.

D_{X}( ) represents a generated decryption algorithm for client number x.

F_{X}( ) represents an invertible function used to transform key K to generate an instance of client key Kₓ.

F⁻¹_{X}( ) is the inverse of transformation function F_{X} and is used to generate custom made decryption algorithm D_{X}( ).

G_{K}( ) represents key generator section or process 340.

G_{D}( ) represents decryption generator section or process 350.

K represents a main key.

K_{X} represents a generated client key number x.

M represents the message or content.

C represents cypher-content.

Therefore, E(K,M) generates cypher C. D(K, C) generates the message or content M from cypher-content C. First, E( ) generates cypher-content C based on K and M, thus E(K,M)→C. G_{K}( ), which uses F_{X}( ) uses K as an input to generate K_{X}, thus, G_{K}(F_{X}( ), K)→K_{X}. G_{D} uses F⁻¹_{X}( ) to generate custom made decryption algorithm D_{X}( ) from main decryption algorithm D( ), thus, G_{D}(F⁻¹_{X}( ), D)→D_{X}( ). For a simple example, let F_{X}(K)=K−X+3. Therefore, F⁻¹_{X}( )=K+X−3. Also, for ease of discussion, in one embodiment encryption section or process 330 includes an XOR function. Therefore, E(K,M)=M XOR K=C. Therefore, main decryption section or process 315 is D(K, C)=C XOR K=M. Key generator section or process 340 is G_{K}(F_{X}, K)→K_{X}={K−X+3). Therefore, G_{D}(F⁻¹_{X}, D)→D_{X}(K_{X}, C)={C XOR(K_{X}+X−3)}. Thus, for the instance where K=2(K₂) and M is represented as the number 5 (M=5), then C=5 XOR 2=7. For K=3, K₃=2−3+3=2, and D₃(K_{X}, C)={C XOR (K_{X}+2)}. Thus, D₃(2,7)=7 XOR (2+3−3)}=5=M. Likewise, for K=4, K₄=2−4+3=1, and D4(K_{X}, C)={C XOR (K_{X}+1)}. Therefore, D₄(1,7)={7 XOR (1+4−3)}=5=M. Therefore, it can readily be seen that if another individual client key is used in the custom made decryption process other than the correct individual client key, the cypher-content will not decrypt correctly. For example, if K₄ is used instead of K₃ in P₃, the decrypted text will be D₃(1,7)={7 XOR (1+3−3)}=6, which is not equal to M which is 5. One should note that the example just presented is a simplistic approach. The chosen invertible function is such a function that will make compromising virtually impossible if an attacker finds a break already found in one clients individual customized decryption process. One should also note that the invertible function may be changed periodically to decrease the chances of compromise.

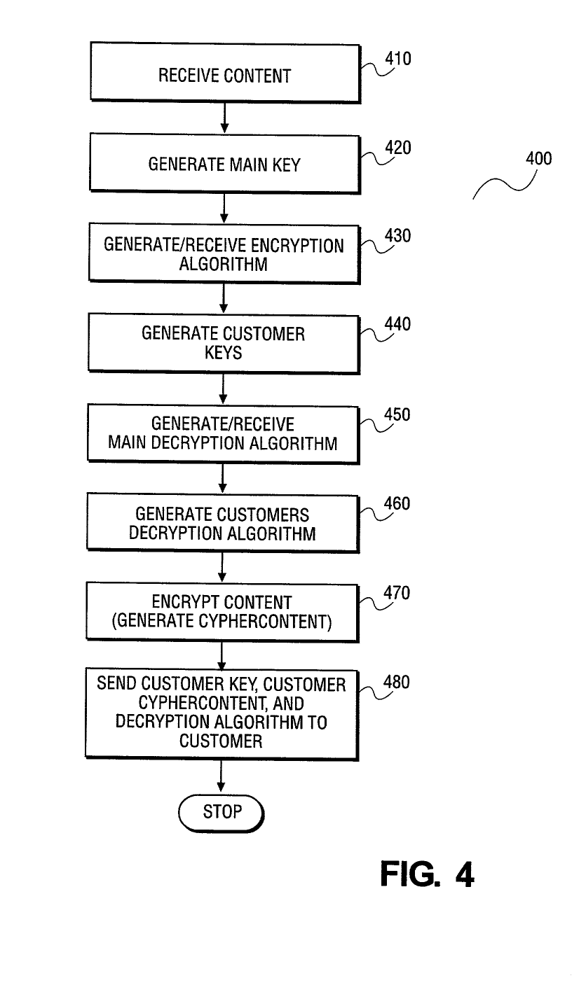

FIG. 4 illustrates a flow diagram of one embodiment of the invention comprising process 400. Process 400 begins with block 410. In block 410, content 325 that is to be encrypted is received. After content 325 is received, block 420 generates main key 320. After main key 320 is generated, main encryption process 330 is generated or received. In case of main encryption process 330 being received, main encryption process 330 is sent out to another possible entrusted entity that needs to encrypt secure content. Main encryption process 330 may be received by conventional means, such as downloaded through a network, received as an email attachment (.e.g., Internet), or received on a recordable medium (floppy disk, CD-ROM, etc.). Encryption process 330 is generated so as to create cypher-content that is capable of decryption by main decryption process 315 and generated decryption processes 370, 371, 372, and 373.

Process 400 continues with block 440 where customer keys are generated. Process 400 continues with block 450 where main decryption process 315 is received or generated. Main decryption process 315 may be received by conventional means, such as downloaded through a network, sent as an email attachment (.e.g., Internet), recordable medium (floppy disk, CDROM, etc.), or by conventional mail. Main decryption process 315 is generated so as to decrypt cypher-content to result in content that was encrypted by main encryption process 330.

Process 400 continues with block 460 where customer decryption processes 370, 371, 372, 373 are generated. Content 325 is then encrypted by main encryption process 330. Process 480 sends customer keys 360, 361, 362, 363, cypher-content 335, and decryption processes 370, 371, 372, and 373 to various customers by conventional means, such as downloaded through a network, sent as an email attachment (.e.g., Internet), or recordable medium (floppy disk, CD-ROM, etc.).

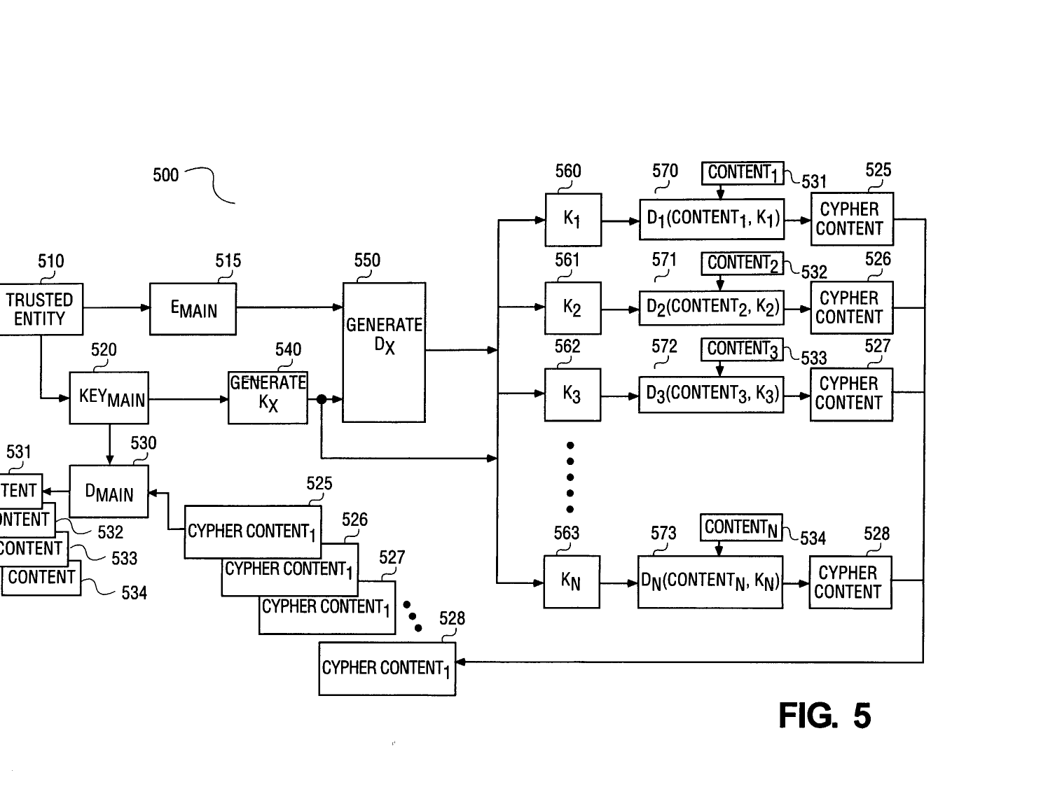

FIG. 5 illustrates an embodiment of the invention comprising semi-symmetric decryption/encryption system 500. Semi-symmetric system 500 comprises trusted entity 510, main encryption section or process 515, main key 520, main decryption section or process 530, encryption generator section or process 550, and key generator section or process 540. Main decryption section or process 515, main decryption section or process 530, encryption generator section or process 550, and key generator section or process 540 of semi-symmetric encryption/decryption system 500 may be incorporated on a circuit or on a machine readable storage device readable by a machine, such as a computer system. Main key 520 can be any cryptographic key having large enough size and randomness to allow for enough entropy to help prevent compromise by various techniques, such as a brute force technique. Also, main key 320 should be periodically modified to decrease the chance of main key 320 being compromised. Content 531, 532, 533 and 534 are content that are desired to be encrypted. Content 534 is the nth content to be encrypted. Content 531, 532, 533, 534 may be content such as text, moving picture experts group (MPEG) files, MPEG audio layer 3 (MP3) files, video on demand (VOD) streams, etc. Content 531, 532, 533, 534 may also be any formatted file to be created in the future. Cypher-Content 525, 526, 527, 528 is distributed an entity desiring to decrypt the cypher-content by conventional means, such as downloaded through a network, sent as an email attachment (.e.g., Internet), or recordable medium (floppy disk, CD-ROM, etc.). Main decryption section or process 530 decrypts cypher-content 525, 526, 527, 528 to produce content 531, 532, 533, 534. Main decryption section or process 530 may be any standard decryption technique, advanced technique or custom decryption technique. Main encryption section or process 515 may be any standard encryption technique, advanced technique or custom encryption technique, and is implemented to correspond to main decryption section or process 530.

Key generator section or process 540 generates individual keys 560, 561, 562, and 563. Key 563 is the nth key generated. Encryption generator section or process 550 generates individual encryption processes 570, 571, 572 and 573. Encryption process 573 represents the nth encryption process. Each encryption process 570, 571, 572, 573 uses the specific key, 560, 561, 562, 563, generated for the specific encryption process.

In one embodiment, key generator section or process 540 uses the same type of functions as key generator section or process 340 (illustrated in FIG. 3). Individual keys 560, 561, 562, and 563 are then distributed to clients by conventional means, such as downloaded through a network, sent as an email attachment (.e.g., Internet), recordable medium (floppy disk, CD-ROM, etc.), or by conventional mail. Since main key 520 may be modified periodically, individual keys 560, 561, 562, and 563 need to be re-generated and distributed accordingly.

Encryption generator section or process 550 uses main encryption section or process 515 and keys generated from key generator section or process 540 as inputs to generate individual encryption processes 570, 571, 572, and 573. Each encryption process 570, 571, 572, 573 is a variation of main encryption process 515. Encryption processes 570, 571, 572, and 573 are then distributed to clients by conventional means, such as downloaded through a network, sent as an email attachment (.e.g., Internet), or recordable medium (floppy disk, CD-ROM, etc.). Since main key 520 may be modified periodically, encryption processes 570, 571, 572, and 573 need to be regenerated and distributed accordingly.

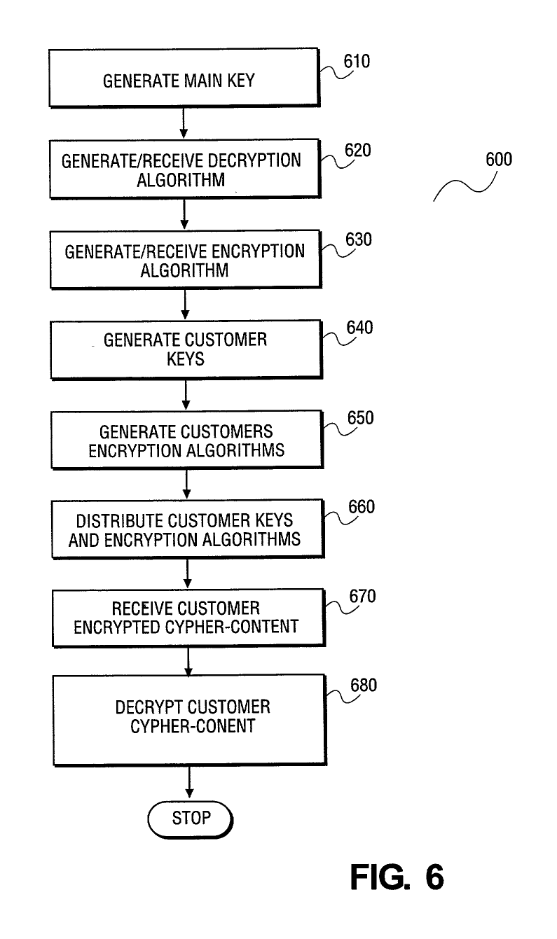

FIG. 6 illustrates a flow diagram of one embodiment of the invention comprising process 600. Process 600 begins with block 610. In block 610, main key 520 is generated. After main key 520 is generated, block 620 generates or receives main decryption process 530. Main decryption process 530 may be received by conventional means, such as downloaded through a network, received as an email attachment (.e.g., Internet), or received on a recordable medium (floppy disk, CD-ROM, etc.). Main decryption process 530 may also be generated, so as to decypher cypher-content generated by customer encryption processes 570, 571, 572 and 573 to produce content 531, 532,533 and 534. In one embodiment, cypher-content may be a signature. The signature, once returned, can be verified by a trusted entity having access to main decryption process 530. It should be noted that main decryption process 530 typically should not be sent to customers, but only trusted entities.

Process 600 continues with block 630 where main encryption process 515 is received or generated. Main encryption process 515 may be received by conventional means, such as downloaded through a network, sent as an email attachment (.e.g., Internet), recordable medium (floppy disk, CDROM, etc.), or by conventional mail. Main encryption process 515 may be generated, so as to encrypt content to result in cypher-content that can be decrypted by main decryption process 530. It should be noted that main decryption process 515 typically should not be sent to customers, but only trusted entities.

Process 600 continues with block 640 where customer keys are generated. Next, block 650 generates customer encryption processes 570, 571, 572, and 573. Process 660 distributes customer keys 560, 561, 562, 563, and encryption processes 570, 571, 572 and 573 by conventional means, such as downloaded through a network, sent as an email attachment (.e.g., Internet), or recordable medium (floppy disk, CD-ROM, etc.). Customers can then encrypt personal content 531, 532, 533 and 534 by using their customer keys and encryption processes. Cypher-content 525, 526, 527, 528 can be sent by the individual customers by conventional means, such as downloaded through a network, sent as an email attachment (.e.g., Internet), or recordable medium (floppy disk, CD-ROM, etc.). Process 670 receives the customer sent cypher-content 525, 526, 527, 528. Process 680, using main decryption process 530, decrypts the cypher-content into content 531, 532, 533 and 534.

In another embodiment, the embodiments illustrated in FIGS. 3 and 5 can be combined. In this embodiment, individual keys are distributed to customers similarly to system 300 and 500. In this embodiment, however, both decryption generator section or process 350 and encryption generator section or process 550 co-exist. This way, customers will be distributed custom keys, and custom decryption and encryption processes. Individual customers will be able to decrypt content sent to them, and encrypt their own content to be sent to a trusting authority having a main key, main decryption process, and main encryption process. Main key should be periodically modified to decrease the likelihood of the main key being compromised. In this case, individual keys, decryption and encryption processes need to be re-generated and distributed accordingly.

By creating individual customer keys, embodiments of the invention reduce the chances of all customers having keys compromised. Thus, if an attacker gains access to one customer's key, it is much more difficult for the attacker to reproduce the attack to gain access to other customer's keys. Also, companies that sell content, such as text, MPEG files, MP 3 files, and VOD streams, that are encrypted so keys are necessary to decrypt the content will not lose as much profit due to attackers.

Therefore, it can be seen for one embodiment of the invention that a distributor of media, such as audio files, is sent decryption agents and individualized keys. The distributor could then load the decryption agents on server databases. When the distributor's customers request (or purchase) the audio files, the distributor can then securely encrypt the audio files. The distributor can then send the encrypted audio file along with the customized key and customized decryption agent to their customer.

Since the method of producing custom made encryption/decryption agents can be standardized, it will be easier to analyze the agents to find security weaknesses over time. This allows agent designers to improve the agents to increase the resistance to attacks.

Also, since custom encryption agents can be sent to users, users will have more confidence that the content that they send will be less likely to be compromised. Other users will not be able to decrypt the cypher-content since the individual keys only work for the individual encryption agents, and/or the individual decryption agents.

The above embodiments can also be stored on a device or medium and read by a machine to perform instructions. The device or medium may include a solid state memory device and/or a rotating magnetic or optical disk. The device or medium may be distributed when partitions of instructions have been separated into different machines, such as across an interconnection of computers.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A circuit comprising:
a key generating section, the key generating section generating a plurality of individual keys based on a main key;
a decryption generating section coupled to the key generating section and a main decryption section, the decryption generating section generating a plurality of individual decryption processes based on the main decryption section and the plurality of individual keys; and
a main encryption section, the main encryption section using the main key to encrypt content.

2. The circuit of claim 1, wherein the plurality of individual decryption processes to each use one of the plurality of individual keys.

3. The circuit of claim 2, wherein the plurality of individual decryption processes decrypt the content from the cypher-content by using the plurality of individual keys.

4. A circuit comprising:
a key generating section, the key generating section generating a plurality of individual keys based on a main key;
an encryption generating section coupled to the key generating section and a main encryption section, the encryption generating section generating a plurality of individual encryption processes based on the main encryption section and the plurality of individual keys; and
a main decryption section, the main decryption section using the main key to decrypt cypher-content.

5. The circuit of claim 4, wherein the plurality of individual encryption processes to each use one of the plurality of individual keys.

6. The circuit of claim 5, wherein the plurality of individual encryption processes encrypt the content forming the cypher-content by using the plurality of individual keys.

7. A method comprising:
generating a plurality of individual keys based on a main key;
generating a plurality of individual decryption processes based on a main decryption process and the plurality of individual keys; and
encrypting content based on an encryption process and the main key.

8. The method of claim 7, further comprising:
distributing the plurality of individual keys to a plurality of customers;
distributing the plurality of individual decryption processes to the plurality of customers; and
distributing cypher-content to the plurality of customers.

9. The method of claim 8, wherein the plurality of individual decryption processes to each use one of the plurality of individual keys.

10. The method of claim 9, the encrypting to generate a cypher-content from the content.

11. The method of claim 10, wherein the plurality of individual decryption processes decrypt the content from the cypher-content by using the plurality of individual keys.

12. A method comprising:
generating a plurality of individual keys based on a main key;
generating a plurality of individual encryption processes based on a main encryption process and the plurality of individual keys; and
decrypting cypher-content based on a main decryption process and the main key.

13. The method of claim 12, further comprising:
distributing the plurality of individual keys to a plurality of customers;
distributing the plurality of individual encryption processes to the plurality of customers; and
receiving cypher-content from the plurality of customers.

14. The method of claim 12, wherein the plurality of individual encryption processes to each use one of the plurality of individual keys.

15. The method of claim 12, the main decryption process to generate a content from the cypher-content.

16. The method of claim 15, wherein the plurality of individual encryption processes encrypt the content forming the cypher-content by using the plurality of individual keys.

17. A program storage device readable by a machine comprising instructions that cause the machine to:
generate a plurality of individual keys based on a main key;
generate a plurality of individual decryption processes based on a main decryption process and the plurality of individual keys; and
encrypt content based on an encryption process and the main key.

18. The program storage device of claim 17, wherein the plurality of individual decryption processes to each use one of the plurality of individual keys.

19. The program storage device of claim 18, the encrypting to generate a cypher-content from the content.

20. The program storage device of claim 19, wherein the plurality of individual decryption processes decrypt the content from the cypher-content by using the plurality of individual keys.

21. A program storage device readable by a machine comprising instructions that cause the machine to:
distribute a plurality of individual keys to a plurality of customers;
distribute a plurality of individual decryption processes to the plurality of customers; and
distribute cypher-content to the plurality of customers.

22. The program storage device of claim 21, wherein the plurality of individual decryption processes to each use one of the plurality of individual keys.

23. The program storage device of claim 21, wherein the plurality of individual decryption processes decrypt the content from the cypher-content by using the plurality of individual keys.

24. A program storage device readable by a machine comprising instructions that cause the machine to:
generate a plurality of individual keys based on a main key;
generate a plurality of individual encryption processes based on a main encryption process and the plurality of individual keys; and
decrypt cypher-content based on a main decryption process and the main key.

25. The program storage device of claim 24, wherein the plurality of individual encryption processes to each use one of the plurality of individual keys.

26. The program storage device of claim 24, the main decryption process to generate a content from the cypher-content.

27. The program storage device of claim 25, wherein the plurality of individual encryption processes encrypt the content forming the cypher-content by using the plurality of individual keys.

28. A program storage device readable by a machine comprising instructions that cause the machine to:
distribute a plurality of individual keys to a plurality of customers;
distribute a plurality of individual encryption processes to the plurality of customers; and
receive cypher-content from the plurality of customers.

29. The program storage device of claim 28, wherein the plurality of individual encryption processes to each use one of the plurality of individual keys.

30. The program storage device of claim 29, wherein the plurality of individual encryption processes encrypt the content forming the cypher-content by using the plurality of individual keys.
